(19) United States
(12) Patent Application Publication
(10) Pub. No.: US 2008/0094192 A1
(43) Pub. Date: Apr. 24, 2008

(54) Lock Apparatus and Method of Use

(76) Inventor: Kane Dutt, Reno, NV (US)

Correspondence Address: KLARQUIST SPARKMAN, LLP, 121 SW SALMON STREET, SUITE 1600, PORTLAND, OR, 97204, US

(21) Appl. No.: 11/661,545

(22) PCT Filed: Sep. 1, 2005
(86) PCT No.: PCT/US05/31392

§ 371 Date: Feb. 27, 2007

Related U.S. Application Data
(60) Provisional application No. 60/606,825, filed on Sep. 1, 2004.

(51) Int. Cl. B62H 5/00

(52) U.S. Cl. 340/427

(57) ABSTRACT

Embodiments of a lock apparatus for securing a cycle frame and methods of use of a cycle lock. According to one exemplary embodiment, a cycle lock apparatus includes a first cycle locking section securably associated with the housing and a second cycle locking section adjustably mounted with respect to the first cycle locking section between a locking position and an unlocked position. The apparatus has a rigid housing and a locking mechanism mounted within the rigid housing. The locking mechanism can have wireless activation circuitry, a power supply section connected to the wireless activation circuitry and at least one lock activation member in communication with the wireless activation circuitry and adjustably mounted within the housing to a locking position in locking communication with the second cycle locking section and an unlocked position with respect to the second cycle locking section. The apparatus can also have a wireless activator.

### CROSS REFERENCE TO RELATED APPLICATION

This application claims the benefit of prior pending U.S. Provisional Patent Application No. 60/606,825, filed on Sep. 1, 2004, which is incorporated by reference in its entirety.

### FIELD

The present disclosure relates to lock apparatus and methods of use. In one embodiment, the present disclosure relates to an apparatus that can lock a cycle in position with respect to another object.

### BACKGROUND

Bicycle theft, and other types of cycle theft, have long presented very significant and widely recognized problems. These problems arise not only when cycles are in use but also when in storage or during transport of cycles from one place to another.

Common cycle locking apparatus include padlocks, chains, wirelocks, and U-locks. These types of locking apparatus are typically portable and secure a portion of a cycle, such as a wheel or the frame, to another object, such as a tree, bike rack, fence, etc.

These types of devices can be effective in preventing theft. They can be particularly unreliable or difficult to use, however, when a cycle is stored or transported. For example, when stored in a garage, the user often has difficulty finding an effective object to which a cycle may be securely locked with these types of apparatus. In addition, locking a cycle with these types of devices requires substantial time and effort by the user to orient the cycle in position, mount the separate lock on the cycle and other object, lock the separate lock, and then, when desired for reuse of the cycle, unlock the separate lock with a key or combination and then reversing the process. The user may often forget to lock the cycle in position or simply chose to refrain from locking the cycle in position due to time constraints, a false sense of security, or a variety of other circumstances.

One solution has been to provide a cycle rack mounted to a wall. The user mounts the cycle on the rack and then utilizes a lock, such as a padlock, chain, or wire lock, or U-lock, to lock the cycle on the fixed rack. These types of racks are usually relatively easily removed from the associated wall, however, such as by removing the exposed fasteners securing the rack to the wall. In addition, these types of racks typically still require the user to first mount the cycle on the rack, then mount the separate lock to the rack, lock the separate lock, and then, when desired for use or transport of the cycle, unlock the separate lock with a key or combination and perform the reverse, time consuming, de-mounting of the lock prior to removal of the cycle from the rack. Again, the user may often fail to lock the cycle to the rack due to the time and effort required to lock and unlock the cycle to the rack.

One prior art device provides a cycle-wheel-locking clamp that mounts to a wall or other object. The user locks the cycle in position by positioning a wheel rim within the clamp, closing the clamp around the wheel rim, and then locking the clamp in position with a separate padlock. Again, the user must store and utilize a separate padlock, and only the cycle's wheel is really secured in position. A thief can steel the balance of the cycle by, for example, disconnecting the wheel from the cycle frame.

U.S. Pat. No. 6,057,657 entitled “Magnetically Operated Bicycle Antitheft Device,” to Kitamura et al, discloses bicycle locks that are activated to unlock by magnetic or wireless controls. Although this reference discloses locks that open more quickly than conventional keyed or combination locks, this reference does not otherwise disclose how to solve problems by, among other things, reliably ensuring locking of cycle in position when storing or transporting a cycle.

Additional information may be found in the following references: U.S. Pat. No. 5,945,794, entitled “Power Saving Antitheft Control Device for a Bicycle,” to Kitamura; U.S. Pat. No. 5,917,407, entitled “Unattended Automatic Bicycle Rental Station,” to Squire et al; U.S. Pat. No. 5,836,002, entitled “Anti-Theft Device,” to Morstein et al; U.S. Pat. No. 5,278,538, entitled “Bicycle Security System” to Ainsworth et al; and U.S. Pat. No. 4,920,334, entitled “Security System for Bicycles, Ski Racks and Coat Racks,” to DeVolpi.

### SUMMARY

It is to be understood that the following is a brief summary of various aspects of the disclosure and/or various embodiments of the disclosure. Other aspects of the disclosure and/or various embodiments of the disclosure will become apparent as this specification proceeds. This brief summary is therefore neither exhaustive nor determinative of the scope of the present application, and given embodiments need not include all features recited herein nor solve all issues or problems with the prior art noted above.

The applicant has invented a lock apparatus having a relatively fixed object mount with an object locking mechanism. In certain embodiments, the locking mechanism is mounted in a housing and accessible through a locking clamp or other structure moveably or adjustably mounted with respect to the housing, and the locking clamp or structure may secure the locking mechanism within the housing.

In one embodiment, the lock apparatus may include wireless activation circuitry and optionally a portable, preferably handheld, wireless activation device for activating the wireless activation circuitry.

In certain embodiments, the wireless communication vehicle may be optical, magnetic, sonic, or radio frequency. The wireless activation circuitry may include code or encryption capability, which the user may adjust in order to customize the code or encryption technique for the user's application.

In some embodiments, the apparatus can include biometric lock activation circuitry mounted within the lock housing in communication with the lock mechanism.

In certain embodiments, the lock mount includes a wall or other mounting device. The mounting device may include one or more wall mount fastening devices that can be inaccessible without activation of the integral cycle frame lock to access the wall mount fastening device.

The object mount may include a cycle frame mount, whereby the cycle may be mounted, for example, adjacent a wall and, if desired, suspended above the floor. The frame mount may in addition or alternatively provide a frame mount positioning support that may allow the cycle frame support to move or spin on the wall (or other mounting object) in the event someone seeks to remove the frame mount from the wall (or other mounting object) by force.

In one embodiment, the frame mount positioning support includes a break-away mounting wedge that mounts below the frame support, supports the frame mount (preferably in compression), and orients the frame mount in a desired position on a wall (or other object). Preferably, if the frame mount is tampered with, such as by trying to remove it from the object to which it is attached, the mounting wedge may break away and allow the frame mount to move. Preferably, this may cause activation of an associated alarm and may render further effort to remove the frame mount from the object more difficult by, for example, allowing the frame mount to spin about a fastener securing the frame mount to the object.

The lock apparatus may include other structure, such as a rigid mounting plate in order to secure the frame mount in position with respect to the object to which it is secured.

In certain embodiments, the lock apparatus includes a rigid housing that houses: (i) the wireless activation circuitry, (ii) a power supply, and (iii) a locking member activatable between a closed and open position within the rigid housing by the wireless activation circuitry. The lock apparatus also can include a rigid cycle frame clamp member that both: (i) clamps a cycle frame to the rigid housing; and (ii) in cooperation with the locking member locks the clamp in position, preferably without need for mounting any additional locking structure or device. The rigid housing and frame clamp can be made of a strong, relatively difficult to penetrate material.

In certain embodiments, a frame clamp member can have a rotatable swing clamp. The swing clamp may rotate, or otherwise move, into or out of position when the locking member is in the unlocked position.

In one embodiment, the frame clamp member has circular or U-shaped cross section, or as otherwise desired to embrace the periphery of a cycle frame. Cycle frame inserts may also be insertable into the frame clamp member in order to adapt the frame clamp member and insert to embrace the periphery of a cycle frame and secure the cycle frame in position with respect to the cycle frame mount.

The lock apparatus may include a rigid wall plate mountable to a wall or other object, such as an automotive vehicle for transport of a cycle. In specific implementations, the apparatus may include an object mounting pole having a first securable end. Further, the mounting plate has a pole mounting surface mountable to the object mounting pole. The rigid wall plate may provide a more substantial and secure mounting surface for mounting of the cycle frame mount.

In certain embodiments, the lock apparatus can include sensors to report environmental conditions and detect, for example, motion, heat, or tampering with the frame mount or object secured to the lock apparatus. The sensors may set off an internal or other alarm (such as a building alarm system, a pager or a cell phone report, for example) when they sense or detect excessive motion, heat, or tampering, such as by causing the mounting wedge to break away. The sensors are preferably mounted within the housing of the cycle frame mount.

Certain embodiments include a removable battery, battery conservation regulation, and internal power induction capability. Preferably, these features are also mountable within the housing of the lock apparatus.

The lock apparatus can be strong, secure, long lasting, aesthetically attractive, versatile, and yet relatively economical to manufacture and easy to use and maintain. In certain embodiments, the apparatus is adapted to provide a sensory indication, such as a visual indication, that the apparatus is unlocked or in an unsecured state. The apparatus can also be adapted to mount to various objects, such as a bicycle rack or pole. A bicycle rack or pole as described herein can provide efficient use of space and security for securely storing one or more bicycles.

Features of the present disclosure can include methods of use of the disclosed apparatus or other apparatus that may provide the process(es) of the one or more such methods.

The foregoing and other features and advantages of the invention will become more apparent from the following detailed description, which proceeds with reference to the accompanying figures.

### BRIEF DESCRIPTION OF THE DRAWINGS

The preferred embodiments of the present invention are shown in the accompanying drawings in which:

FIG. 1 is a schematic of a rotatable swing clamp embodiment of a cycle lock embodiment, showing alternative wireless lock activation devices;

FIG. 2a is a side cross-sectional view of an alternative rotatable swing clamp embodiment mounted to a wall or other plate, such as the side of a vehicle;

FIG. 2b is a plan view, and partial side cross-sectional view, of the rotatable swing clamp embodiment of FIG. 2a;

FIG. 2c is a plan view, and partial side cross-sectional view, of the rotatable swing clamp embodiment of FIG. 2a with the swing clamp removed;

FIG. 2d is partially sectional view of the rotatable swing clamp embodiment of FIG. 2a, showing (i) the mounting housing (enclosure) footprint on the associated wall plate and (ii) a breakaway orienting wedge;

FIG. 3 is an elevational view of an alternative insertable swing clamp embodiment, also showing the insertable swing clamp in partial cross-section;

FIG. 4 is a cross-sectional side view of swing clamp embodiment of FIG. 2a showing the operation of removing and inserting the battery pack and shown with an electronic control system;

FIG. 5 is an exploded view of an alternative embodiment of a cycle lock apparatus;

FIG. 6 is a partially sectional view of the cycle lock apparatus of FIG. 5 taken along the line 6-6 in FIG. 5;

FIG. 7 is a bottom view of the cycle lock apparatus of FIG. 5 shown with a housing bottom plate removed;

FIG. 8 is a sectional perspective view of the cycle lock apparatus of FIG. 5 taken along the line 8-8 in FIG. 7;

FIG. 9 is a perspective view of a lock apparatus rack shown with multiple lock apparatus mounted thereto and a bicycle secured to each of the apparatus.

FIG. 10 is an elevational side view of the lock apparatus rack of FIG. 9.

In the following detailed description, spacially orienting terms such as “horizontal,” “upper,” and “lower” are used. It is to be understood that these terms are for convenience of description with respect to the drawings and not themselves necessarily limiting of the orientation of any given component in space.

### DETAILED DESCRIPTION OF THE PREFERRED EMBODIMENTS

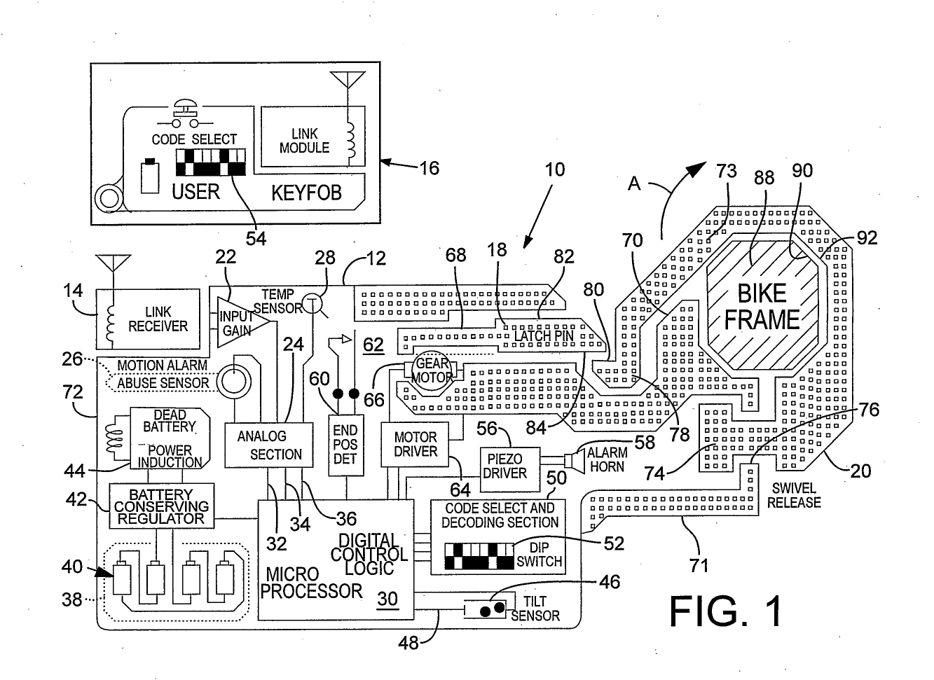

With reference to FIG. 1 and according to one embodiment, a cycle lock apparatus, generally 10, has a cycle frame mount/lock housing 12, a swing clamp 20 rotatably secured to the cycle frame mount/lock housing 12, a wireless communications receiver module, generally 14, and a portable wireless transmitter keyfob, generally 16. The wireless communication receiver module 14 and mating transmitter keyfob 16 may cooperatively provide a magnetic flux link, an ultra-sonic link, an infra-red link, or a radio frequency link. The transmitter keyfob 16 thus wirelessly communicates from one such link with the mating receiver module 14 in order to activate a latch pin 18 to either lock down or release the rotatable swing clamp 20.

Within the cycle frame mount/lock housing 12, the system electronics include a receiver input gain section 22 connected to an analog-to-digital converter section 24. A motion sensor and alarm 26 that senses motion and temperature sensor and alarm 28 that can sense an increase in temperature, a decrease in temperature, or in some embodiments, both are also connected to the analog-to-digital converter 24. In turn, the analog-to-digital converter 24 provides three inputs 32, 34, 36 into a microprocessor 30. The three inputs 32, 34, 36 provide digital input into the microprocessor 30 for each of the receiver input gain section 22, motion sensor and alarm 26, and temperature sensor and alarm 28, respectively.

A removable battery pack 38 contains four small batteries, generally 40. The battery pack 38 is connected to a battery conserving regulator 42, and the battery conserving regulator 42 is also connected to a dead battery internal power induction section 44. The battery conserving regulator 42 also is connected to the microprocessor 30, and the microprocessor 30 is thus informed of the status of the batteries 40.

A tilt sensor alarm 46 also provides input 48 to the microprocessor 30, as does a code selection and decoding section 50. The code selection and decoding section 50 includes dip switches, generally 52, which the user may set to mate with the setting of dip switches 54 on the keyfob 16. In this manner, the wireless communications between the keyfob 16 and the microprocessor may be coded in a fashion well known to those skilled in the art. Other communication security techniques may also be used, such as encryption.

A piezo horn driver section 56 is connected to an alarm horn 58. In turn, the microprocessor 30 is connected to the piezo horn driver section 56 in order to control activation of the alarm horn 58 when any of the other alarm sensors, e.g., 46, signal an associated alarm condition to the microprocessor 30 or the microprocessor is informed of a low battery condition as explained above.

A latch pin end position detector section 60 also is connected to the microprocessor 30. The latch pin end position detector section is mounted adjacent a latch pin open or fully withdrawn position 62 within the housing 12.

A motor driver section 64 is connected to the microprocessor 60 in order to activate an associated latch pin gear motor 66 upon command from the microprocessor 30 and the associated receiver input gain section 22. The latch pin gear motor 66 thus mates with the mating pinion gear teeth section 68 on the horizontally disposed and laterally slidable latch pin 18.

The system electronics can also include an externally accessible programming port for facilitating programming and debugging operations of the microprocessor 30.

Alternative, or in addition, to using a keyfob, the cycle lock apparatus may achieve authentication by using a biometric sensor mounted to the mount/lock housing, to receive input of a user's personal feature(s), such as the user's fingerprints, retina, face, voice and comparing the inputted personal feature(s) against a stored data file containing the personal feature characteristics of authorized users located on a microprocessor, such as microprocessor 30. If the input from the sensor matches the personal feature(s) of an authorized user stored in the file, an unlock signal is generated by the microprocessor to open the cycle lock apparatus.

Similarly, alternative to, or in addition to, using a biometric sensor, a tapping system for receiving input from a user in the form of physically tapping a portion of the lock apparatus. The tapping system includes a vibration sensor, including a piezo electric transducer, coupled to a spring. The vibration sensor is coupled to an analog to digital converter, which is electrically coupled to a microprocessor, such as microprocessor 30 or a dedicated microprocessor. The microprocessor analyzes a digital signal received from the analog to digital converter and, if authentication is successful, sends a signal to a motor driver, such as motor driver 64, to retract or unlock a latch. In some implementations, a user taps the apparatus a certain number of times corresponding to a pre-authorized code stored in data file on the microprocessor. In some implementations, the tapping system includes a biometric sensor that receives a series of taps in the form of a rhythmic pattern. The system analyzes the rhythm and the way the rhythm was tapped and compares this information with data stored in a file on the microprocessor.

When used as an alternative to a keyfob or other physical object to access the bicycle lock, sensors, such as biometric sensors, to access the lock provide a user, e.g., a cyclist, with the capability of unlocking the lock without the added weight and inconvenience of carrying and keeping track of a physical device or object.

The housing 12 includes a bicycle frame base support 70 and the frame base support 70 and the swing clamp 20 extend from the exposed or free end 71 of the housing 12 opposite the mounting end 72 on the housing 12. An arcuate or somewhat U-shaped cross-section 73 of the swing clamp 20 has a secured end 74 rotably secured within a swivel mounting passage 76 in the exposed end 71 of the housing 12. The swing clamp 20 has an openable locking end or arm 78 opposite the secured end 74. The locking end 78 has a locking lip 80 that extends horizontally under a mating end surface 84 of the latch pin locking arm 82 when the swing clamp 20 and latch pin 18 are in the locked, cycle frame clamping position (as shown in FIG. 1).

In this position, the swing clamp 20 may secure a two-piece cycle frame clamp 88, which in turn may provide an interior passage adapted to grip the periphery of a cycle frame (not shown in FIG. 1). The frame clamp 88 may be adapted to have an external periphery that has one or more planar exterior surfaces, e.g., 90, that abut mating swing clamp planar interior surfaces, e.g., 92, and thereby secure the swing clamp 88 in position with respect to the frame clamp 20 and housing 12. In addition, the cycle frame clamp 88 may be customized for various cycles in order to more securely retain them within the frame clamp 88 and reduce the likelihood of marring or scratching the surface of the cycles mounted with the frame clamp 88. In this regard, the cycle frame clamp or adapter kit 88 may be made of a relatively soft yet resilient and durable material, such as molded polyurethane, that abuts the cycle frame when mounted within the cycle frame clamp 88.

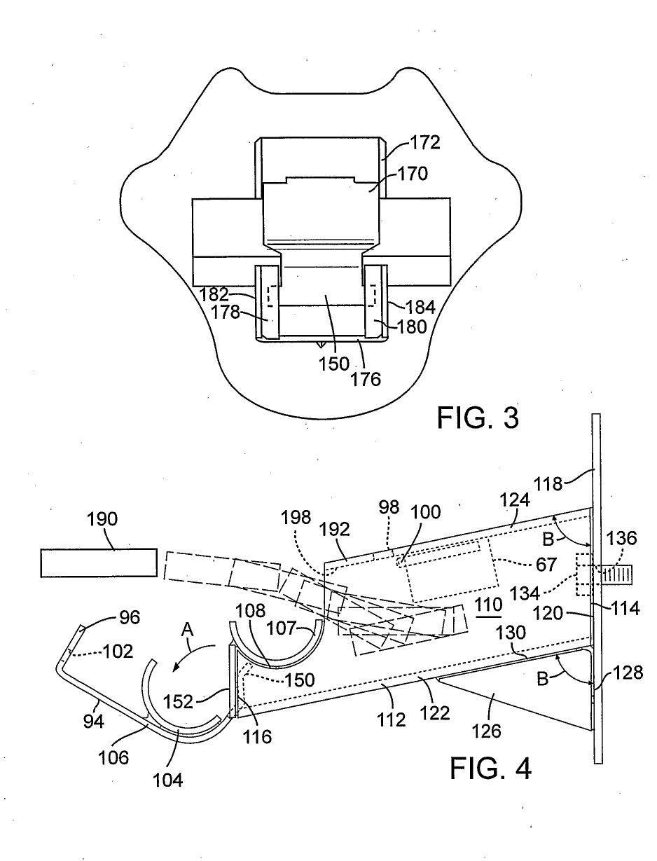

When, however, the microprocessor 30 activates the gear motor 66 to move the latch pin 18 toward to the withdrawn or open position 62, the locking end 78 is thereby free to rotate in a direction A away from the latch pin 86 and thereby open the swing clamp 20 (see, e.g., FIG. 4). This allows the user to remove the frame clamp 88 and any cycle frame mounted within the cycle lock apparatus 10.

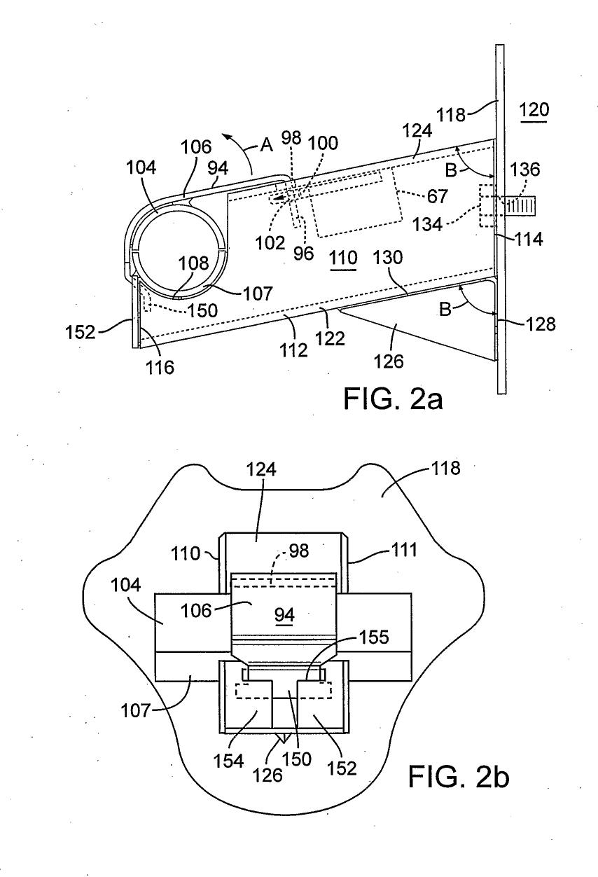

With reference now to FIGS. 2a, 2b, and 2c, an alternative swing clamp 94 has an L-shaped end 96 that penetrates a laterally extending clamp orifice 98 in the lock housing 112. A gear mechanism 67 can move the latch pin or rack slide bolt 100 to lock the L-shaped end 96 in position by penetrating a mating bolt strike passage 102 in the L-shaped end 96 of the swing clamp 94. The swing clamp 94 also has an upper semi-circular bike frame clamp section 104 welded to the partially arcuate clamping portion 106 of the swing clamp 94. The upper bike frame clamp section 104 mates with a lower semi-circular bike frame support section 107 abutting mating U-shaped support passages, e.g., 108, in the planar sides, e.g., 110, 111 of the cycle lock housing or base enclosure 112.

The base enclosure or housing 112 has a planar mounting end 114 opposite the cycle locking end 116. The mounting end 114 can abut a planar mounting plate 118 secured to a mounting surface 120 such as the surface of a garage wall.

The base enclosure or housing 112 has a planar bottom side 122 parallel with a planar top side 124. The mounting end 114 abuts the planar bottom and top sides 122, 124 forming an acute angle B between the mounting end 114 and the bottom side 122 and top side 124.

A three-sided, pyramid shaped support wedge 126 has a planar mounting end 128 mounted to the matingly planar surface of the mounting plate 118. The upper planar end 130 of the support wedge 126 supportingly abuts the mating planar bottom side 122 of the base enclosure 112. The support wedge 126 thus bears most of the load of the cycle lock apparatus and associated cycle (not shown) in compression between the mounting plate 118 and the bottom side 122 of the base enclosure 112.

With reference now to FIG. 2d, the support wedge 126 is supported on the wall or mounting plate 118 by a relatively easily breakable or removable fastener (not shown) penetrating the support wedge 126 and a mating fastener positioning key-hole or passage 132 in the mounting plate 118. The cycle lock housing or base enclosure 112 is secured adjacent the mounting plate 118 by a strong, heavy-duty fastener 134 penetrating, as shown in FIG. 2a, a mating fastener passage 136 in the mounting plate 118 and planar mounting end 114 of the housing 112.

In the event of tampering with the cycle lock apparatus such as by trying to remove it from an attached object such as a wall, the breakable or removable fastener releases the support wedge 126, allowing the cycle lock housing 112 to spin about heavy-duty fastener 134. This renders separation of the housing 112 from the attached object more difficult and also trips the motion sensor and associated alarm (described above) within or otherwise associated with the housing 112.

With reference again to FIGS. 2a, 2b, and 2c, the swing clamp 94 has a T-shaped end 150 rotably secured within a swivel mounting passage 155 defined by the planar right and left swivel plates 152, 154 secured to the mating free or locking end 116 of the housing 112. When the rack slide bolt 100 is activated to slide away from the bolt strike passage 102, the swing clamp 94 is thereby free to rotate about its T-shaped end 150 outwardly in the direction A away from the lower frame support section 107 (see FIG. 4). In some embodiments, the T-shaped end 150 has a radiused engaging surface where the T-shaped end 150 contacts the swivel plates 152, 154 as the swing clamp rotates to reduce friction and wear. In other embodiments, friction and wear can be reduced by mounting a rounded rod (not shown) to the T-shaped end 150 adjacent the engaging surface. The rounded rod can be made from a durable material, such as stainless steel to minimize wear and rust.

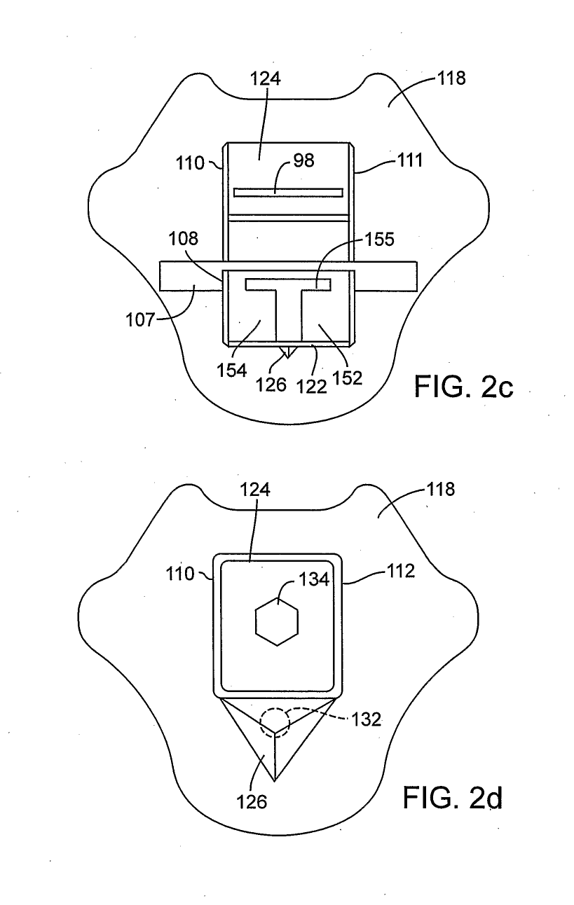

With reference now to FIG. 3, an alternative swing clamp 170 may be removed from the cycle frame mount/lock housing 172 and re-inserted into position in the housing 172. In this position, the T-shaped end 174 of the swing clamp 170 is confined adjacent the free end 176 of the housing 172 by the two co-planar swivel plates 178, 180 welded to the free end 176 closely adjacent but transverse to the left and right sides 182, 184 of the housing 172.

With reference now to FIG. 4, a battery pack 190 may be removably mounted within the interior confines of the cycle frame mount/lock housing 112 intermediate the rack slide bolt or latch pin 100 and electronic control system, generally 196 (described above with reference to FIG. 1). The battery pack 190 may thus be removed through a battery mounting channel 198 in the housing 112 above the lower cycle frame support section 107 when the swing clamp 94 is rotated outwardly in the direction A away from the lower frame support section 107, as shown in FIG. 4.

In order to use the cycle lock apparatus described above, the user mounts the frame mount to a wall or other object, inserts batteries into the frame mount, and then mounts a frame kit if needed or desired. In order to use the cycle lock apparatus, the user merely: (i) mounts a cycle to the frame mount; and (ii) locks the cycle lock apparatus by depressing a button on the keyfob or other locking activation mechanism. The cycle is thereby stored and secured in position without further user effort.

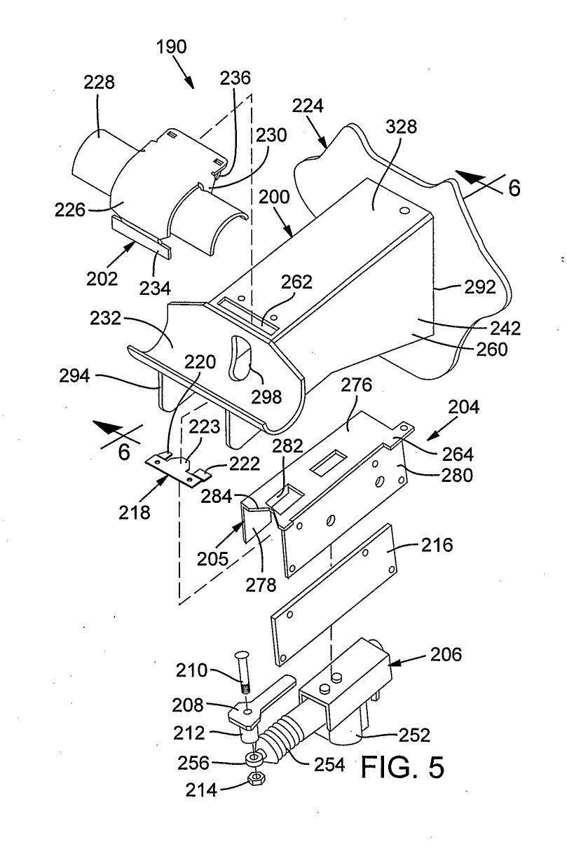

An alternative embodiment of a cycle lock apparatus is shown in FIGS. 5-8. Referring to FIG. 5, a cycle lock apparatus, indicated generally at 190, includes a cycle frame mount/lock housing 200, a swing clamp 202 rotatably secured to the housing 200 and a locking mechanism 204.

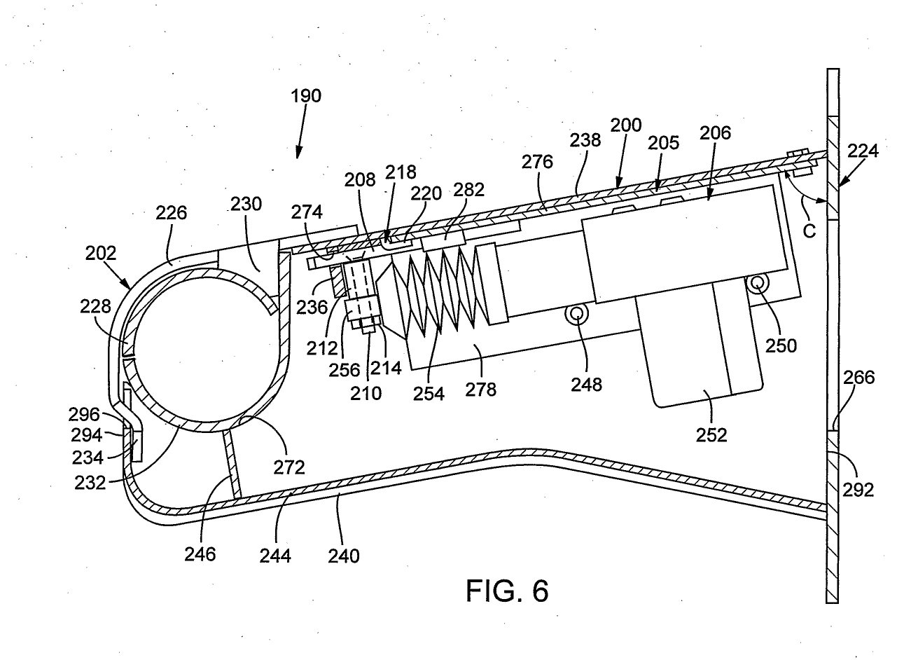

The lock housing 200 can have a planar top wall 238 generally opposing a bottom wall 244 (see FIG. 6). The top and bottom walls 238, 244, respectively, extend from a free, or cycle supporting, end 294 of the housing 200 to abut a planar mounting plate 224 at a mounting end 292 of the housing. An acute angle C (see FIG. 6) is formed between the top wall 238 and the mounting plate 224 where the top wall abuts the mounting plate.

The lock housing 200 also have two opposing planar side walls 240, 242 extending parallel to each other from the free end 294 of the housing to abut the planar mounting plate 224 at the mounting end 292 of the housing transversely to the plane of the planar mounting plate. The side walls 240, 242 also extend transverse to and abut the top wall 238 and the bottom wall 244. In some implementations, the side walls 240, 242 are formed by bending the walls away from the top wall 238 and the bottom wall 244 is attached, such as by welding, to the side walls a distance away from the top wall.

The side walls 240, 242 include a support portion 260 proximate the mounting end 292 of the housing 200. The support portion 260 has a lower edge that is generally downwardly angled with respect to an upper edge of the side walls 240, 242 such that the height of the side walls 240, 242 at the mounting end 292 of the housing 200 is more than the side walls proximate the free end 294 of the housing. The increased height translates into enhanced load bearing support by the housing 200 when the apparatus 190 is mounted to an object such as a wall and a cycle (not shown) is secured in the apparatus.

The housing 200 can be immovably and securely mounted to the mounting plate 224 by welding the mounting end 292 of the side walls to the plate.

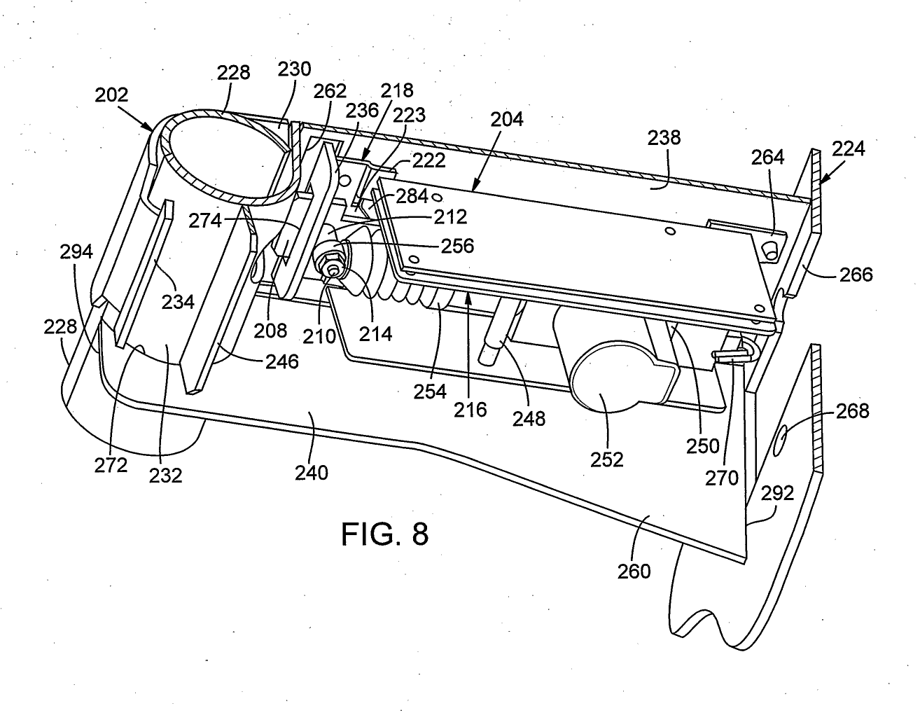

Proximate its free end 294, the lock housing 200 includes generally upwardly extending U-shaped or C-shaped support passages, e.g., support passage 272 (as best shown in FIGS. 6 and 8), formed in the housing side walls 240, 242. The housing also includes a generally upwardly extending U-shaped or C-shaped elongate bicycle frame support section 232 that abuts the support passages and is immovably secured, such as by welding, to the support passages. The support section 232 is sized to at least partially support a bicycle frame or frame component positioned therein. Additionally, the support section 232 can include a slot 298 penetrating the support section for ease of installation of the lock apparatus 190 and to provide access to the internal components of the apparatus when the apparatus is in an unsecured state.

The swing clamp 202 of the bicycle lock apparatus 190 includes a generally downwardly extending U-shaped or C-shaped elongate upper clamp section 228 that abuts and is coupled, such as by welding, to a generally arcuate exterior section 226. The exterior section 226 has an upper end portion extending generally parallel to the top wall 238 of the lock housing 200 and a lower end portion extending generally transverse to the upper end portion. To help strengthen the bond between the exterior portion 226 and the upper clamp section 228, a pair of clamp section mounting tabs 230 extending transversely to the upper end portion of the exterior section 226 can be bonded to the upper clamp section 228. The tabs 230 can have an arcuate interior surface that abuts a portion of the exterior surface of the upper clamp section 228 not welded to the exterior portion 226 (see FIG. 6). In this way, bonding strength between the upper clamp section 228 and the exterior section 226 is enhanced and security is increased by preventing access to the internal components within the lock apparatus through openings between the exterior section 226 and the upper clamp section 228.

The swing clamp 202 also includes a hasp plate 236 coupled to and transversely extending from the upper end portion of the exterior section 226. The hasp plate 236 is sized to extend through an elongate clamp orifice 262 extending laterally across a width of the top wall 238 of the housing 200. A T-shaped portion 234 adapted to at least partially secure the swing clamp 202 to the housing 200 is formed in the lower end portion of the exterior portion 226.

The locking mechanism 204 is mounted to an interior of the lock housing 200. The locking mechanism 204 includes a housing 205, system electronics board 216, actuator 206 and latch 208. The housing 205 includes a top wall 276, two parallel side walls, 278, 280 abutting and perpendicularly extending away from the top wall and an open bottom. The locking mechanism housing 205 provides added security and protection of those components mounted therein. The top wall 276 includes a pair of parallel latch guide tabs 282 abutting and extending perpendicularly from the top wall and a lock housing mounting tab 264 that includes a fastener opening.

The system electronics board 216 can be a printed circuit board (PCB) having some or all of the electrical components and circuitry described above. The electronics board 216 can be mounted to an interior surface of one of the locking mechanism side walls.

The actuator 206 can include a gear motor 252 in engagement with an actuating rod 256 that is protected by a collapsible sleeve 254. The gear 252 is operable to extend the actuating rod 256 toward the free end 294 of the lock housing 200 and retract the actuating rod 256 away from the free end 292 of the lock housing. The latch 208 includes a fastener opening that receives a latch mounting fastener 210. The latch 208 is mounted to the actuator 206 by inserting the latch mounting fastener 210 through the fastener opening in the latch, through a spacer element 212, and through a passage in the actuating rod 256, and then securing the fastener 210 to the rod 256 engaging a fastener element, such as nut 214, to the latch mounting fastener. The latch 208 being mounted to the rod 256 in this manner is thus configured to extend toward the free end 294 of the lock housing 200 and retract away from the free end of the lock housing as the rod is driven by the gear motor 252. In some embodiments, the gear motor 252 is incased in a waterproof casing or coating with a water-resistant coating.

The bracket 218 can be a generally plate-like element having a first outer tab 220, a second outer tab 222 and a tapered central mating tab 223 positioned between the first and second outer tabs. The first and second outer tabs 220, 222 are elevated with respect to the central mating tab 223 by forming an S-type bend in the bracket 218.

Now referring to FIG. 6, the upper clamp section 228 matingly abuts the bicycle frame support section 232 when the swing clamp 220 is coupled to the lock housing 200 in the closed position as shown. The interior surfaces of the upper clamp section 228 and the frame support section 232 define a generally cylindrical-shaped space in which a bicycle frame or component attached to a bicycle frame can be secured. Although the upper clamp section 228 and the swing clamp 220 are generally U-shaped or C-shaped to define a generally cylindrical-shaped spaced when abutting each other, it is recognized that the upper clamp section and swing clamp can have other shapes, such as rectangular or triangular, which define other shaped spaces for securing bicycle frames or components of varying shapes and sizes.

The T-shaped portion 234 of the swing clamp 202 extends through and is secured by a passageway, or notch, 296 with a width smaller than the width of the T-shaped portion formed in an upwardly extending portion of the housing bottom wall 244 proximate the housing free end 294. Once secured by the passageway 296, the swing clamp 202 is allowed to rotate freely from an open position to the closed position about its T-shaped end when the lock apparatus 190 is in an unsecured state. In some embodiments, the T-shaped portion 234 has a radiused engaging surface where the T-shaped end 234 contacts the housing bottom wall 244 as the swing clamp rotates to reduce friction and wear. In other embodiments, friction and wear can be reduced by mounting a rounded rod (not shown) to the T-shaped end 234 adjacent the engaging surface. The rounded rod can be made from a durable material, such as stainless steel, which can also minimize rust.

The lock apparatus 190 is placed in a secured state by securing the T-shaped portion 234 in the passageway 296 and rotating the swing clamp 202 until the hasp plate 236 extends through the clamp orifice 262. The hasp plate 236 includes a latch locking slot 274 through which the latch 208 extends when the actuating rod 256 of the actuator 206 is extended upon receiving an electronic signal from a motor driver, such as motor driver 64 in FIG. 1, to lock the apparatus. In this position, the latch 208 prevents the swing clamp 202 from rotating away from the bicycle frame support section 232 to place the lock apparatus 190 in the secured state. In the secured state, a bicycle frame placed on the support section 232 is prevented from being removed from the support section 232 by the upper clamp section 228.

As mentioned above, the electronic signal sent to the actuator 206 to lock the apparatus can be initiated by sending a locking signal from a wireless keyfob, such as keyfob 16. Alternatively, the locking apparatus 190 can have a microswitch mounted within the housing 200 proximate the hasp plate 236 such that when the hasp plate 236 extends through the clamp orifice 262, it contacts and depresses the microswitch. The microswitch is electronically coupled to either the microprocessor or the motor driver and, when depressed by the hasp plate 236, transmits a locking signal to the microprocessor or the motor driver, which correspondingly sends a signal to the gear motor to extend the latch.

Although not shown, when the actuating rod 256 and latch 208 are retracted to place the lock apparatus 190 in the unsecured state, the latch is positioned away from the slot 274 such that the swing clamp 202 is once again free to rotate away from the support section 232. The bicycle frame is thereby allowed to be removed from the support section 232 and thus the cycle lock apparatus 100.

In some implementations, a spring element can be coupled to the lock apparatus 190 intermediate the swing clamp 202 and the housing top wall 238 to bias the swing clamp away from the top wall. When the latch 208 is retracted away from the slot 274 to place the lock apparatus 190 in the unsecured state, the spring urges the swing clamp 202 to lift, or otherwise move away from the housing top wall 238, to provide a user with a visual indication that the apparatus is unlocked or in the unsecured state.

A portion of the latch 208 can positioned between the parallel latch guide tabs 282 to guide the latch, i.e., maintain proper alignment of the latch relative to the mating latch locking passage 274, as its moves between the extended and retracted positions.

The locking mechanism housing 205 is secured within the lock housing 200 by using the locking mechanism mounting bracket 218 and a cycle frame housing mounting tab 264. The bracket 218 is mounted to an interior surface of the housing top wall 238 such that an upper surface of the central mating tab 223 is flush with the interior surface of the housing top wall 238. With the first and second outer tabs 220, 222 being downwardly elevated with respect to the central mating tab 223, spaces are defined between the first and second outer tabs 220, 222, respectively, and the interior surface of the housing top wall 238.

The end of the locking mechanism housing top wall 276 in which notch 284 is formed can be slidably inserted into the spaces between the first and second tabs 220, 222, respectively, and the top wall 276. A fastening mechanism can then be inserted into an opening formed in the lock housing mounting tab 264 and an opening formed in the housing top wall 238 to secure the end of the locking mechanism housing top wall 276 proximate the mounting tab 264 to the interior surface of the lock housing top wall 238. In this way, the locking mechanism 204 can be mounted to and dismounted from the housing 200 by attachment and removal, respectively, of a single fastener.

As the locking mechanism housing top wall 276 is slidably inserted into the spaces between the first and second tabs 220, 222, respectively and the top wall 276, the central mating tab 223 of the mounting bracket 218 is matingly received in the notch 284 formed in the locking mechanism housing top wall 276. The central mating tab 223 being matably engaged with the notch 284 assists in preventing lateral movement of the locking mechanism housing 205 with respect to the lock housing 200.

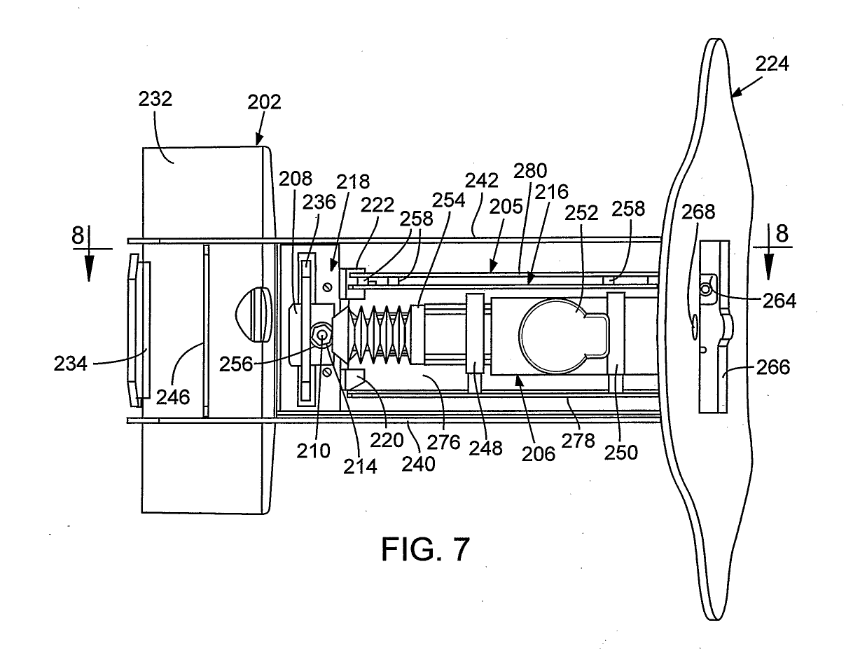

Referring now to FIG. 7, in some embodiments, the mounting bracket 218 can extend around the clamp orifice 262 such that, when in the extended position, a portion of the bracket is positioned between an end portion of the latch 208 extending beyond the hasp plate 236 and the housing top wall 238. In this way, the end portion of the latch 208 is at least partially supported against the bracket 218 to assist in preventing the leading end portion of the latch 208 from bending upwards as a result of tampering of the swing clamp 202 while latch is in the extended position and the lock apparatus 190 is in a secured state.

The systems electronics board 216 can be connected to the locking mechanism housing side wall 280 in a spaced apart relation by extending fasteners through openings in the board, side wall and spacers 258 positioned intermediate the board and the side wall, and securing the fasteners using a bolt or other fastening element.

Referring now to FIG. 8, the gear motor 252 can be electrically coupled to the system electronics board 216 via connecting wires 270. More specifically, the connecting wires 270 can electrically connect the gear motor 252 with a motor driver mounted on the system electronics board 216. The actuator 206 can be at least partially held in place within the housing 205 by support rods 248, 250 mounted to the side wall 278.

The housing 200 can also include a security plate, or dam, 246 coupled, such as by welding, to the bicycle frame support section 232, the housing side walls 240, 242 and the housing bottom panel 244 (see FIG. 6), to provide additional resistance to tampering of the apparatus, particularly tampering of the internal components of the apparatus.

The mounting plate 224 can have a window 266 penetrating the plate to allow for easy installation and, if necessary, removal of the locking mechanism 204. Further, a notch formed in the window 266 is used for receiving a strong fastener for mounting the mounting plate 224 to an object. An opening 268 penetrating the mounting plate 224 is sized to allow a weak screw to pass through and be secured to the object. The weak fastener prevents the apparatus 190 from tilting and setting off a tilt sensor alarm. In the case of tampering, the weak fastener is designed to break resulting in rotation of the apparatus around the strong fastener and triggering of the tilt alarm sensor.

In some implementations, an opening (not shown) penetrating the mounting plate and spaced above the window 266, rather than the notch form in the window can be used to receive the strong fastener for mounting the mounting plate 224 to an object. In some implementations, an additional opening (not shown) can penetrate the mounting plate 224 and be spaced below the opening 268 and housing 200. The additional opening is thus easily assessable to receive an additional mounting fastener for mounting the plate to an object.

As shown in FIG. 8, the mounting plate 224 can include a drain hole penetrating the mounting plate. The drain hole allows liquid built up within the bicycle lock apparatus over time to drain out of the apparatus. The space defined between the support portion 260 of the side walls 240, 242 and the bottom wall 240 (see FIG. 6) can allow for concentrated build up of liquid in the lock apparatus, such as rain water, which can then drain out of the drain hole.

In specific implementations of the bicycle lock apparatus 190 shown in FIGS. 5-8, the apparatus weights approximately 7.7 lbs.; projects outward approximately 10 inches from a wall on which the apparatus is mounted; has an overall height of approximately 8 inches and an overall width of approximately 9.375 inches; and a lock apparatus housing width of approximately 3.5 inches.

In the embodiments described above, the individual components, such as the frame mount housing, swing clamp, latch pin or latch, swivel plates, clamp or support sections, mounting plate, mounting bracket, security dam and mounting wedge, are all made of strong, rigid, and long lasting material. Exemplary material for these and other non-electrical or electronic components include steel, aircraft aluminum, or stainless steel, for example. In some specific implementations, the bicycle lock apparatus housing is made of 14-gage 1018 cold rolled steel and the mounting plate is made of 10-gage 1018 cold rolled steel. In some implementations, the apparatus housing can be formed using molding techniques, such as casting and forging.

The lock apparatus described above can be used by first mounting the mounting plate to an object, such as a wall, rack, or pole. The mounting end of the lock housing is then mounted to the mounting plate. The swing clamp is rotated away from the housing and a bicycle is lifted upwards to place its frame on the frame support section of the housing. In some implementations, a frame adapter can first be fastened around the frame of the bicycle prior to placing the frame with attached frame adapter on the support section. The swing clamp is then rotated toward the housing until the hasp plate extends through the passageway in the top wall of the housing. In this position, a user can selectively operate a wireless keyfob or other external device to transmit a locking signal to a signal receiver in the housing, or enter a code or biometric identification into a receiving device on or in the housing, to lock the lock apparatus. Alternatively, a microswitch can be triggered by a portion of the swing clamp as the swing clamp is rotated toward the housing to lock the apparatus and secure the bicycle frame in place.

A user desiring to unlock the apparatus can selectively operate the wireless keyfob or other external device to transmit an unlocking signal to the signal receiver in the housing, or enter a code or biometric identification in the receiving device, to unlock the apparatus. The user can then rotate the swing clamp away from the housing and remove the bicycle frame from the frame support section of the housing.

In the unsecured state, a user can easily remove the lock apparatus from a first object, such as a wall, and mount the apparatus to a second object, such as a motor vehicle to transport the bicycle to another location. In the secured state, any tampering of the apparatus, such as by attempting to remove the mounting plate from an object, will cause at least one of the several sensors within the housing to trigger an alarm.

Further, the cycle lock apparatus is relatively small and can be easily portable and shippable prior to mounting.

It can thus be seen that the foregoing cycle lock apparatus provide both cycle storage and security in one apparatus. The apparatus is relatively easy to use, strong, longs lasting, and economical and easy to manufacture, install, or re-install if needed. It can help reduce the possibility of damage to an associated cycle when mounted in the apparatus, even when the apparatus is subject to tampering. It also provides alarms for various types of tampering or possible damage to the apparatus or associated cycle, and the alarms may be contained within the apparatus or provided by separate alarm systems, such as a building alarm system with which the apparatus may readily be adapted to communicate, including wirelessly if desired. In addition, the cycle lock apparatus may provide a convenient and reliable support for working with or maintaining a cycle mounted in the apparatus.

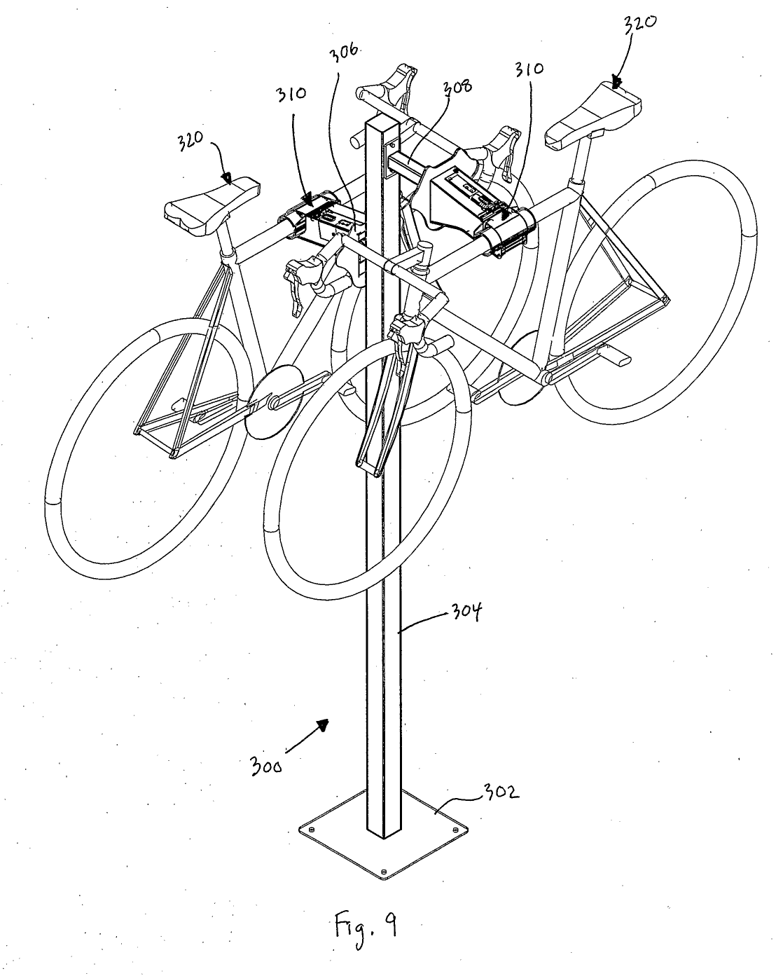

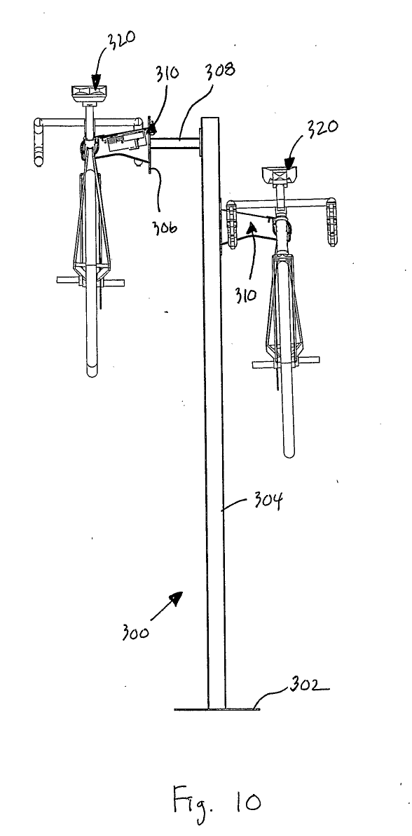

The apparatus also may be adapted, such as by increasing or decreasing the surface area of the mounting plate, to mount to various types of objects, including walls, posts, transportation vehicles, or other secure objects. For example, as shown in FIG. 9, a rack 300 on which one or more bicycle lock apparatus 310 securing bicycles 320 can be mounted has a planar base plate 302 secured to the ground, e.g., a concrete surface, using non-removable fasteners (not shown), and a vertically extending mounting post 304 coupled, such as by welding, and extending transversely to the base plate. The mounting post 304 can have a generally rectangular or square shaped cross-section with planar exterior surfaces to facilitating attachment of a lock apparatus mounting plate 306 directly to the post. Alternatively, an extension bracket 308 can be mounted to the mounting post 304 at a first, or mounting, end and a mounting plate 306 at a second, or free, end. As best shown in FIG. 10, when mounted to the mounting post 304, the extension bracket 308 extends horizontally from and transversely to the mounting post to provide increased separation between a secured bicycle 320 and the mounting post 304.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A cycle lock apparatus, comprising in combination:
(A) a rigid housing;
(B) a first cycle locking section securably associated with the housing;
(C) a second cycle locking section adjustably mounted with respect to the first cycle locking section between a locking position and an unlocked position;
(D) a locking mechanism mounted within the rigid housing and having (i) wireless activation circuitry; (ii) a power supply section connected to the wireless activation circuitry; and (iii) at least one lock activation member in communication with the wireless activation circuitry and adjustably mounted within the housing to a locking position in locking communication with the second cycle locking section and an unlocked position with respect to the second cycle locking section; and
(E) a wireless activator.

2. The cycle lock apparatus of claim 1 wherein the wireless communication vehicle comprises an optical, magnetic, sonic, or radio frequency wireless communication vehicle.

3. The cycle lock apparatus of claim 1 wherein the wireless activation circuitry comprises encrypted code storage.

4. The cycle lock apparatus of claim 1 further comprising an object mounting section associated with the rigid housing and mountable to a secure object and wherein the rigid housing.

5. The cycle lock apparatus of claim 1 wherein the rigid housing also includes a locking mechanism access passage, the second cycle locking section being moveably mounted in the housing from the locking position blocking the locking mechanism access passage and the unlocked position unblocking the locking access passage.

6. The cycle lock apparatus of claim 1 wherein the activation circuitry comprises at least one of a motion sensor, a heat sensor, and a tampering sensor, wherein the sensors are connected to an alarm.

7. The cycle lock apparatus of claim 1 wherein the activation circuitry comprises at least a battery conservation regulator and an internal power induction element.

8. The cycle lock apparatus of claim 1 wherein the first cycle locking section includes a cycle frame support and the second cycle locking section includes a mating cycle frame clamp.

9. The cycle lock apparatus of claim 5 wherein the first cycle locking section includes a cycle frame support and the second cycle locking section includes a mating cycle frame clamp.

10. The cycle lock apparatus of claim 9 wherein: (i) the wireless communication vehicle comprises (a) an optical, magnetic, sonic, or radio frequency wireless communication vehicle; and (b) encrypted wireless code storage; and (ii) also including object mounting section associated with the rigid housing and mountable to a secure object,

11. A cycle lock apparatus comprising in combination:
a lock housing including a cycle abutting section, at least one adjustable clamp section, and an adjustable locking mechanism; and
means for activating the adjustable locking mechanism to secure the adjustable clamp section in cycle locking position with respect to cycle abutting section associated with the lock housing.

12. The cycle lock apparatus of claim 11 wherein the adjustable locking mechanism is mounted within the lock housing, the lock housing is rigid and includes an adjustable locking mechanism access passage, and the adjustable clamp section is adjustably mountable in an access passage blocking position in the cycle locking position.

13. The cycle lock apparatus of claim 12 wherein the cycle abutting section comprises an elongate lower cycle frame supporting portion and the adjustable clamp section comprises an elongate upper clamping portion, the elongate lower cycle frame supporting section and adjustable clamp section cooperatively providing means for locking a cycle in position with respect to the lock housing.

14. The cycle lock apparatus of claim 12 further comprising a housing mount adjustably mountable to a secure object and breakable housing positioning element breakably securing the rigid housing in a fixed position with respect to the housing mount.

15. The cycle lock apparatus of claim 14 further comprising a housing mount adjustably mountable to a secure object and breakable housing positioning element breakably securing the rigid housing in a fixed position with respect to the housing mount.

16. An object locking apparatus comprising in combination:
A. a lock housing having a rigid periphery;
B. a first object locking section mounted to the lock housing;
C. a second object locking section being adjustably mountable with respect to the first object locking section;
D. a lock mechanism adjustably mounted in the lock housing between a locking position in locking communication with the second object locking section and an unlocking position with respect to the second object locking section,
E. a lock mechanism access passage in the lock housing and the second object locking section being blockingly mountable to the lock mechanism access passage in locking communication with the lock mechanism.

17. The object locking apparatus of claim 16 wherein the lock mechanism includes wireless lock activation circuitry and also including a wireless lock activation device.

18. The object locking apparatus of claim 16 wherein the first object locking section includes an object periphery support platform and the second object locking section includes an object periphery clamp.

19. The object locking apparatus of claim 18 wherein the object is a cycle apparatus.

20. The object locking apparatus of claim 16 wherein the object locking apparatus includes an electrical power supply section connected to the lock mechanism.

21. The object locking apparatus of claim 16 also including an apparatus mounting element and at least one fastener device being mounted within the lock housing connecting the mounting element to the lock housing, the fastener device being accessible through the lock mechanism access passage.

22. The object locking apparatus of claim 20 also including an apparatus mounting element and at least one fastener device mounted within the lock housing and connecting the lock housing to the mounting element, the fastener device being accessible through the lock mechanism access passage.

23. The object locking apparatus of claim 16 also including a force-moveable lock housing positioning member in communication with the lock housing and apparatus mounting element.

24. The object locking apparatus of claim 22 also including a force-moveable lock housing positioning member in communication with the lock housing and apparatus mounting element.

25. The object locking apparatus of claim 16 also including environmental sensing circuitry communicatingly connectable to an alarm.

26. The object locking apparatus of claim 24 also including environmental sensing circuitry communicatingly connectable to an alarm.

27. The object locking apparatus of claim 16 wherein the lock mechanism includes biometric lock activation circuitry mounted within the lock housing in communication with the lock mechanism.

28. The object locking apparatus of claim 26 wherein the lock mechanism includes biometric lock activation circuitry mounted within the lock housing in communication with the lock mechanism.

29. The object locking apparatus of claim 21 also including an object mounting pole having a first securable end and wherein the apparatus mounting element has a pole mounting surface mountable to the object mounting pole.

30. The object locking apparatus of claim 28 also including an object mounting pole having a first securable end and wherein the apparatus mounting element has a pole mounting surface mountable to the object mounting pole.

31. The object locking apparatus of claim 29 wherein the object is a cycle apparatus.

32. The object locking apparatus of claim 30 wherein the object is a cycle apparatus.
